(19) United States
(12) Patent Application Publication
(10) Pub. No.: US 2006/0236086 A1
(43) Pub. Date: Oct. 19, 2006

(54) Information processing apparatus and operation control method

(76) Inventors: Hiroyuki Tsuji, Ome-shi (JP); Hiroshi Aiba, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/402,666

(22) Filed: Apr. 12, 2006

(30) Foreign Application Priority Data
Apr. 18, 2005 (JP) 2005-119580

(51) Int. Cl. G06F 9/00

(52) U.S. Cl. 713/2

(57) ABSTRACT

According to one embodiment, an information processing apparatus includes a main body to which an external device is connectable, a power supply control unit configured to turn on a power supply of the main body in response to an operation of one of a first switch arranged on the main body and a second switch arranged on the external device, a determination unit configured to determine whether a power-on factor of the main body is one of the operation of the first switch and the operation of the second switch in response to power-on of the main body, and a control unit configured to boot a first operating system when the power-on factor of the main body is the operation of the first switch, and to boot a second operating system when the power-on factor of the main body is the operation of the second switch.

### CROSS-REFERENCE TO RELATED APPLICATIONS

This application is based upon and claims the benefit of priority from Japanese Patent Application No. 2005-119580, filed Apr. 18, 2005, the entire contents of which are incorporated herein by reference.

### BACKGROUND

1. Field

One embodiment of the invention relates to an information processing apparatus including a main body to which an external device can be connected, and an operation control method used in the apparatus.

2. Description of the Related Art

In recent years, various portable information processing apparatuses such as notebook personal computers have been developed. An external device can be connected to such information processing apparatus to expand the functions of the information processing apparatus, as needed.

Recently, a technique of selectively using a plurality of operating systems in one computer has also been developed.

Jpn. Pat. Appln. KOKAI Publication No. 2001-243076 discloses a data processing system having a function of designating in advance an operating system to be loaded when the system is booted next. In this data processing system, a plurality of operating systems are stored in memory. When the system is booted, the operating system selected in advance by the user is loaded.

However, generally, since the use purpose of the computer can change over time, the operating system which is selected in advance is not always the one desired by the user at the time of use.

Also, a technique can be used, in which the operating system to be booted is selected from an operating system list displayed on a menu window when turning on the power supply of the system. However, in this case, the user selects the operating system in the menu window whenever turning on the power supply of the system. Because of this selection operation, a long period of time is used to boot the system.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing the outer appearances of an information processing apparatus and an external device which is connected to the information processing apparatus according to an embodiment of the invention;

FIG. 2 is an exemplary perspective view showing a state wherein the information processing apparatus and external device shown in FIG. 1 are connected;

FIG. 3 is an exemplary block diagram showing an example of the system arrangement of the information processing apparatus shown in FIG. 1;

FIG. 4 is an exemplary block diagram showing an example of the system arrangement of the external device shown in FIG. 1;

FIG. 5 is a flowchart showing an example of a boot control process of booting an operating system in accordance with a wakeup factor implemented by the information processing apparatus shown in FIG. 1; and

FIG. 6 is a flowchart showing an example of an operation control process executed when an undocking switch is operated by the information processing apparatus shown in FIG. 1.

### DETAILED DESCRIPTION

Various embodiments according to the invention will be described hereinafter with reference to the accompanying drawings.

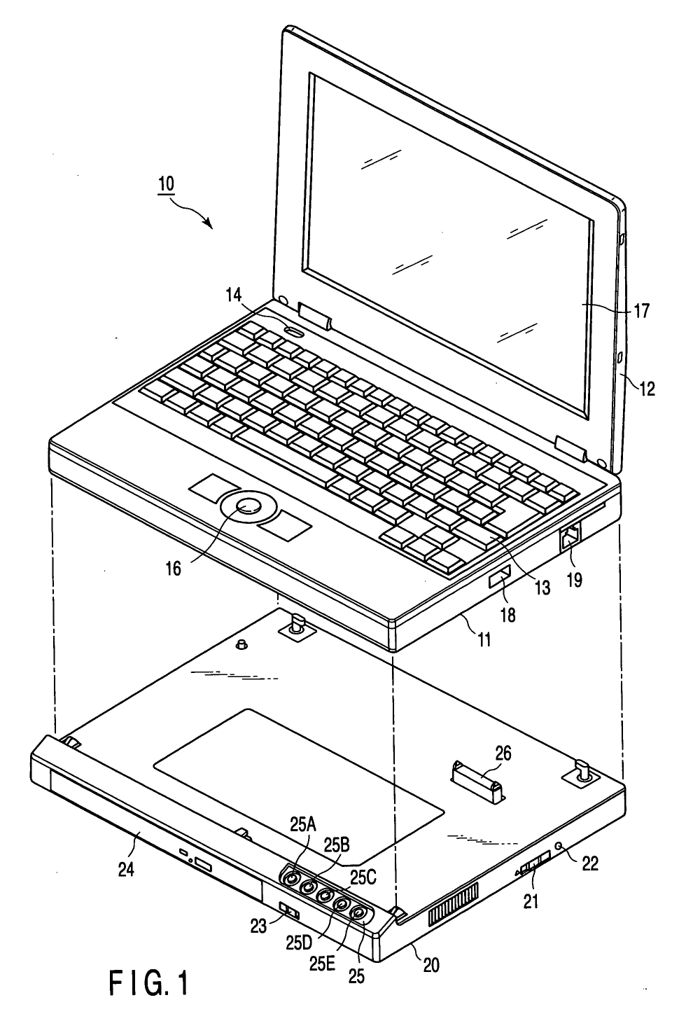

Referring to FIGS. 1 to 3, the arrangement of an information processing apparatus according to an embodiment of the invention will be described below. This information processing apparatus serves as a battery operable and portable notebook personal computer 10. A docking station 20 can be connected as an external device to the notebook personal computer 10. The docking station 20 functions as an expansion unit for expanding the functions of the computer 10.

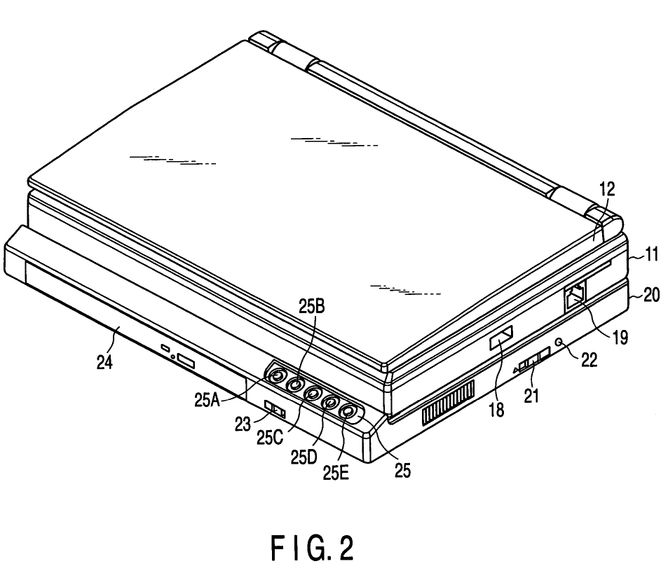

FIG. 1 is an exemplary perspective view showing the outer appearances of the computer 10 and the docking station 20. In FIG. 2, the computer 10 is connected to the docking station 20.

The computer 10 comprises a computer main body 11 and display unit 12. A liquid crystal display (LCD) 17 is built in the display unit 12. The display screen of the LCD 17 is positioned at an approximately central part of the display unit 12.

The display unit 12 is supported by the computer main body 11, and is attached to the computer main body 11 such that the display unit 12 is freely rotatable between an open position where the top surface of the computer main body 11 is exposed and a closed position where the display unit 12 covers the top surface of the computer main body 11.

In one embodiment, the computer main body 11 has a thin box-shaped housing. On the top surface of the computer main body 11, a keyboard 13, a power button switch 14 for powering on/off the computer 10, a pointing stick 16, and the like are arranged.

On the side surface of the computer main body 11, a universal serial bus (USB) port 18, local area network (LAN) port 19, and the like are formed. The USB port 18 is a connector which can be connected to a USB compatible device. The LAN port 19 is a connector which can be connected to a LAN cable.

For example, the docking station 20 serves as an external USB device. For example, in the illustrated embodiment, the docking station 20 has a thin box-shaped housing. In the housing of the docking station 20, an optical disc drive 24 is housed. The optical disc drive 24 is a drive unit for accessing information from a storage medium such as a digital versatile disc (DVD) and compact disc (CD) in which audio/video contents and the like are stored.

The top surface of the housing of the docking station 20 serves as a mounting space for the computer main body 11. On the mount space, a docking interface connector 26 is arranged. When the computer main body 11 is placed on the mounting space, the docking interface connector 26 is connected to a docking interface connector on the bottom surface of the computer main body 11. The computer 10 then identifies the docking station 20 (more specifically, the optical disc drive 24 in the docking station 20) for example, as an external USB device, and adds the docking station 20 as the hardware resource of the computer 10 (docking process).

The housing of the docking station 20 also includes an undocking switch 21, LED 22, hold switch 23, and input operation panel 25.

The undocking switch 21 is an operation switch which issues a request to remove the docking station 20 from the computer 10. When the user operates the undocking switch 21, the computer 10 executes a device removing process (undocking process) for setting the system environment of the computer main body 11 to a state where the docking station 20 can be removed from the computer main body 11. After executing this device removing process, computer 10 no longer uses the docking station 20 as a hardware resource.

An indicator, such as a light emitting diode (LED) 22 indicates the state in which the computer. 10 is connected to the docking station 20. When the computer 10 is connected to the docking station 20, more specifically, during a period in which the computer 10 and the docking station 20 are in the docking state, the LED 22 is on. During the device removing process, the LED 22 is off.

The input operation panel 25 serves as an input unit for inputting an event corresponding to the pressed button switch, and has a plurality of button switches used to activate the respective functions. The button switch group includes a digital versatile disc (DVD)/compact disc (CD) start button switch 25A, playback/pause button switch 25B, stop button switch 25C, fast rewind button switch 25D, and fast forward button switch 25E.

When the user presses the DVD/CD start button switch 25A, an application program for playing back the content stored in the medium such as a DVD or a CD inserted to the optical disc drive 24 is automatically booted up. The playback/pause button switch 25B is a button switch used to issue an instruction to play back content or temporarily stop playback of the content stored in the medium such as the DVD or CD inserted to the optical disc drive 24. The stop button switch 25C is a button switch used to issue an instruction to stop playback of the content stored in the medium such as the DVD or CD. The fast rewind button switch 25D is a button switch used to fast rewind the playback position of the content. The fast forward button switch 25E is a button switch used to fast forward the playback position of the content.

The hold switch 23 is a button switch used to inhibit the operations of the respective button switches of the input operation panel 25. When the hold switch 23 is on, the operations of the respective button switches of the input operation panel 25 are disabled.

When the docking station 20 is connected to the computer 10 (hot docking or hot swapping), the docking station 20 can be powered by the computer 10. The computer 10 can use the docking station 20 as an external device.

As described above, the docking station 20 can be operated via power supplied from the computer 10. For example, the user can carry the docking station 20 with the computer 10, and use the docking station 20 with the computer 10 while traveling.

In addition to a versatile main operating system such as Microsoft® Windows® XP, a dedicated sub operating system, such as an operating system based on Linux, is installed in the computer 10 for playing back the audio/video data.

When the user presses the power button switch 14, the main operating system is booted up. If the main operating system is booted up, the first DVD/CD playback application program starts when the user presses the DVD/CD start button switch 25A in a state where the docking station 20 is connected to the computer 10. The first DVD/CD playback application program is a program for playing back the contents stored in the medium such as the DVD or CD, and operates on the main operating system.

When the user presses the DVD/CD start button switch 25A of the docking station 20 in a state where the computer 10 is off and the docking station 20 is connected to the computer 10, the sub operating system is booted up. The sub operating system then automatically executes the second DVD/CD playback application program. The second DVD/CD playback application program is a program for playing back the content stored in the medium such as the DVD or CD, and operates on the sub operating system.

The sub operating system typically has a relatively small set of functions and executes the function of playing back the multimedia content stored on an optical disk. Hence, the time used for the boot up process of the sub operating system is much shorter than that for the boot up process of the main operating system. Therefore, the user can quickly observe play back of the audio/video content simply by pressing the DVD/CD start button switch 25A while the docking station 20 is connected to the computer 10.

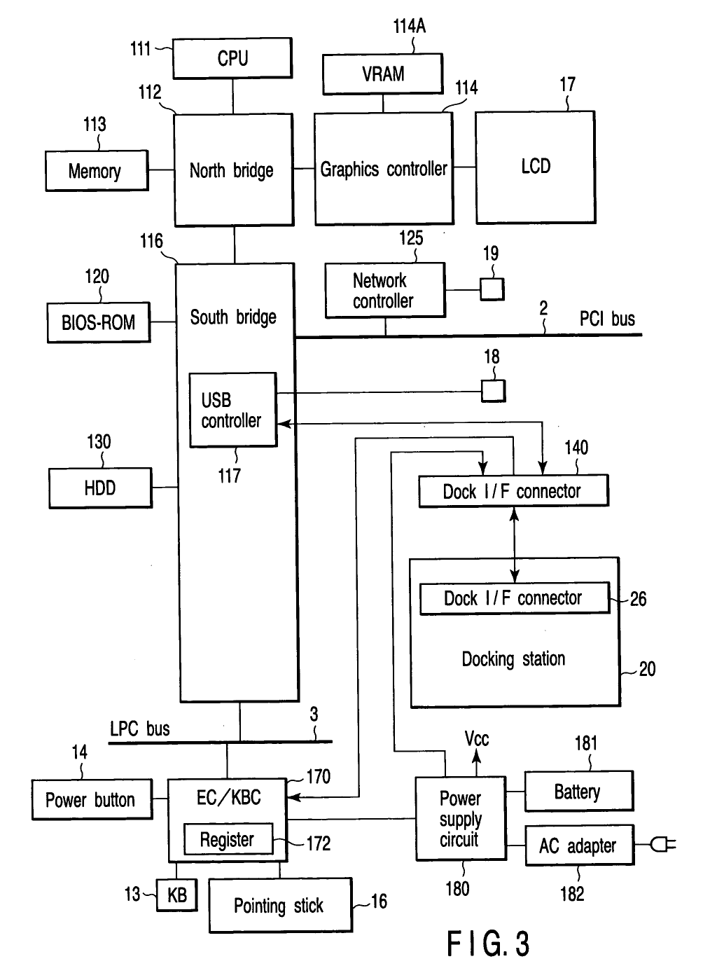

The system arrangement of the computer 10 will be described below with reference to FIG. 3.

The computer 10 comprises a CPU 111, a north bridge 112, a main memory 113, a graphics controller 114, the LCD 17, a south bridge 116, a BIOS ROM 120, a network controller 125, a hard disk drive (HDD) 130, a docking interface (dock I/F) connector 140, an embedded controller/keyboard controller (EC/KBC) IC 170, a power supply circuit 180, and the like.

The CPU 111 is a processor which controls the operations of respective components of the computer 10. The CPU 111 executes an operating system (main operating system or sub operating system) and various application programs which are loaded from the HDD 130 into the main memory 113.

The CPU 111 also executes a system basic input output system (BIOS) stored in the BIOS ROM 120. The system BIOS is a program for hardware control. For the purposes of this disclosure, the system BIOS is not considered as a sub operating system. The system BIOS has a function of executing the above described device removing process (undocking process) in collaboration with the currently executed operating system (main operating system or sub operating system).

The north bridge 112 is a bridge device that is connected to the local bus of the CPU 111 and the south bridge 116. The north bridge 112 also has a function of making a communication with the graphics controller 114 via an accelerated graphics port (AGP) bus or the like. In one embodiment, a memory controller is incorporated in the north bridge 112. The memory controller controls the main memory 113.

The graphics controller 114 is a display controller which controls the LCD 17 used as the display monitor of the computer 10. The graphics controller 114 displays data written in a video memory (VRAM) 114A on the LCD 17, by the operating system (main operating system or sub operating system) or the application program.

An integrated drive electronics (IDE) controller and a USB controller 117 are incorporated in the south bridge 116. The integrated drive electronics (IDE) controller controls the HDD 130. The USB controller 117 controls the USB device. The south bridge 116 is connected to a peripheral component interconnect (PCI) bus 2 and a low pin count (LPC) bus 3.

To the PCI bus 2, the network controller 125 is connected. The network controller 125 executes communication with the external network device via the LAN cable connected to the LAN port 19.

In one embodiment, the EC/KBC IC 170 is a 1 chip microcomputer in which an embedded controller for power supply management, a keyboard controller that controls the keyboard (KB) 13 and pointing stick 16 are integrated. The keyboard (KB) 13 and pointing stick 16 function as input units.

The EC/KBC IC 170 has a function of turning on/off the power supply of the computer 10 in collaboration with the power supply circuit 180 in response to a user's operation of the power button switch 14 or DVD/CD start button switch 25A.

The EC/KBC IC 170 also has a detection unit 171 which detects operations of the button switches 25A to 25E arranged on the input operation panel 25, and operation of the undocking switch 21, in the docking station 20. When the detection unit 171 detects operation of the undocking switch 21, the above described removing process is executed.

The EC/KBC IC 170 also has a function of detecting operation of the power button switch 14 of the computer 10. When the user presses the power button switch 14, the EC/KBC IC 170 turns on the power supply of the computer 10 in collaboration with the power supply circuit 180, and generates wakeup factor information indicating that the power supply of the computer 10 is turned on by pressing the power button switch 14.

When the user presses the DVD/CD start button switch 25A in a state where the computer 10 and the docking station 20 are connected and the power supply of the computer 10 is turned off, the EC/KBC IC 170 turns on the power supply of the computer 10 in collaboration with the power supply circuit 180, and generates wakeup factor information indicating that the power supply of the computer 10 is turned on by pressing the DVD/CD start button switch 25A.

The generated wakeup factor information is set in a register 172 of the EC/KBC IC 170. When the CPU 111 issues a wakeup factor acquisition request, the EC/KBC IC 170 sends the wakeup factor information from the register 172 to the CPU 111.

The power supply circuit 180 generates a system power supply to be supplied to respective components of the computer 10 using an external power supply supplied via an AC adapter 182, or a battery 181. The power supply circuit 180 also generates operation power supply Vcc to be supplied to the docking station 20, under the control of the EC/KBC IC 170.

The computer 10 is connected to the docking station 20 via the docking interface connector 140. In this embodiment, as described above, the docking station 20 comprises with the USB standard, and the optical disc drive 24 in the docking station 20 is controlled by the USB controller 117.

Each of the docking interface connectors 140 and 26 has about 50 pins. As these pins, some power supply pins for supplying an operation power supply voltage from the computer 10 to the docking station 20, some signal pins connected to a USB signal line group, and some signal pins used when the docking station 20 notifies the computer 10 of the state of the button switch group arranged on the docking station 20 are defined.

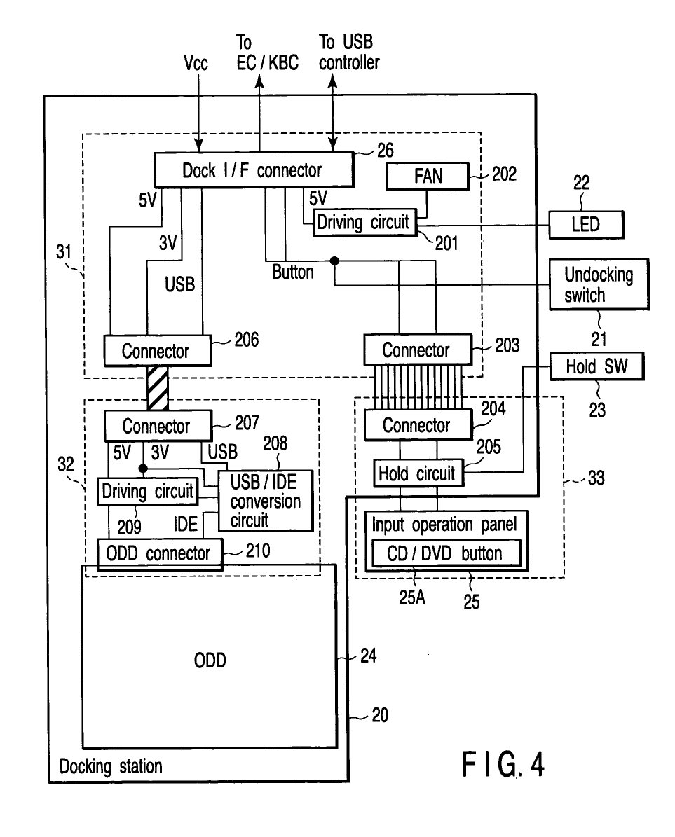

The system arrangement of the docking station 20 will be described next with reference to FIG. 4.

In the illustrated example, the docking station 20 comprises three printed circuit boards 31, 32, and 33.

The docking interface connector 26, a driving circuit 201, an air cooling fan (FAN) 202, and connectors 203 and 206 are mounted on the board 31. The docking interface connector 26 is connected to the driving circuit 201, and connectors 203 and 206 via lines on the board 31. The connector 203 is a connector for connecting the board 31 to the board 33 via a cable. The connector 206 is a connector for connecting the board 31 to the board 32 via a cable or the like.

The driving circuit 201 is a circuit for driving the FAN 202 and the LED 22, and generates power supply voltages for driving the FAN 202 and the LED 22 using a power supply voltage supplied from the computer main body 11 via the docking interface connector 26.

The connector 203 is connected to the signal line group indicating the states of the button switches 25A to 25E on the input operation panel 25, from the board 33 via a cable. The signal line group is connected to the docking interface connector 26, as the button signal line together with the signal line indicating the state of the undocking switch 21. The button signal line is connected to the EC/KBC IC 170 via the docking interface connector 140 of the computer main body 11.

The connector 206 is connected to a connector 207 of the board 32 via a cable. As the cable between the connectors 206 and 207, some power supply lines and USB signal lines are defined.

The connector 207, a USB/IDE conversion circuit 208, a driving circuit 209, and an ODD connector 210 are mounted on the board 32. The connector 207 is connected to the USB/IDE conversion circuit 208, driving circuit 209, and ODD connector 210 via lines on the board 32.

The driving circuit 209 generates power supply voltages to be supplied to the USB/IDE conversion circuit 208 and the optical disc drive (ODD) 24 via the ODD connector 210, using the power supply voltage supplied from the connector 207.

The USB/IDE conversion circuit 208 has a function of converting the USB signal input via the connector 207 into the IDE signal, and a function of converting the IDE signal input from the ODD 24 via the ODD connector 210 into the USB signal.

A connector 204, a hold circuit 205, and the operation button switch group arranged on the input operation panel 25 are mounted on the board 33. The connector 204 is electrically separated from the operation button switch group arranged on the input operation panel 25 by the hold circuit 205 when the hold switch (Hold SW) 23 is on.

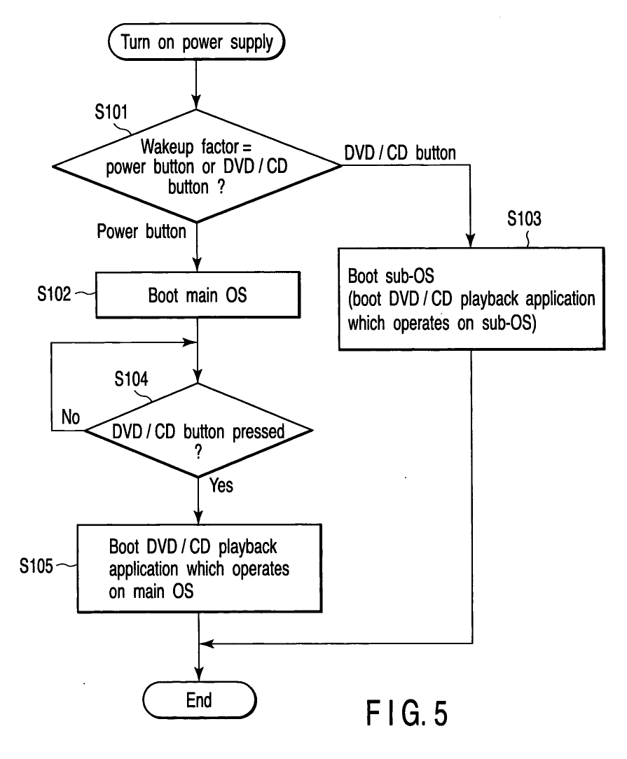

The example of a boot control process executed by the CPU 111 (system BIOS) when the power supply of the computer 10 is turned on will be described next with reference to the flowchart of FIG. 5.

When the power supply of the computer 10 is turned on, the system BIOS determines whether the wakeup factor is the pressing operation of the power button switch 14 or that of the DVD/CD start button switch 25A (block S101). In block S101, the CPU 111 acquires the wakeup factor information set in the register 172 of the EC/KBC IC 170. The CPU 111 determines the wakeup factor of the computer 10 in accordance with the wakeup factor information set in the register 172.

When it is determined that the wakeup factor information indicates the pressing operation of the power button switch 14, the CPU 111 boots the main operating system (block S102).

On the other hand, when it is determined that the wakeup factor information indicates the pressing operation of the DVD/CD start button switch 25A, the CPU 111 boots the sub operating system (block S103). When the sub operating system is booted, it automatically executes the second DVD/CD playback application.

When it is detected that the user presses the DVD/CD start button switch 25A in a state wherein the main operating system is booted (YES in block S104), the main operating system boots the first DVD/CD playback application (block S105).

In this embodiment, the operating system to be booted is automatically selected in accordance with whether the user operates the power button switch 14 of the computer main body 11 or the DVD/CD start button switch 25A of the docking station 20. Hence, when turning on the power supply of the computer 10, two types of operating systems (main operating system and sub operating system) can be easily and selectively booted by the user by pressing the power button switch 14 for using the main operating system, or pressing the DVD/CD start button switch 25A for using the sub operating system (second DVD/CD playback application). It is possible that even when the main operating system is booted, the user can also use the DVD/CD playback application by operating the DVD/CD start button switch 25A.

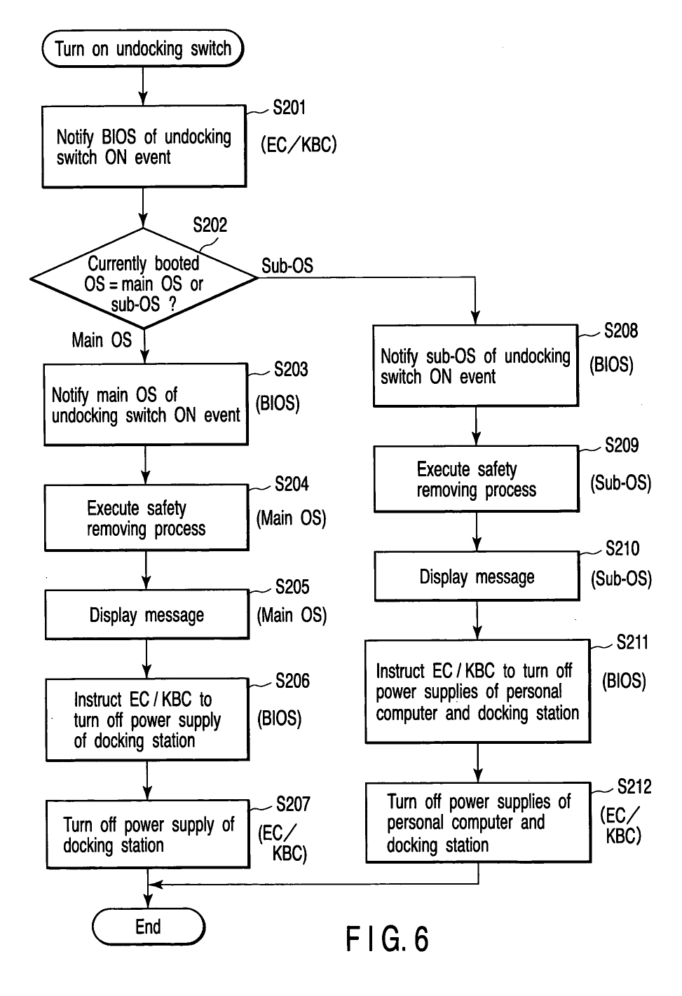

The example of an operation control process executed when the user operates the undocking switch 21 will be described next with reference to the flowchart of FIG. 6. This operation control process is executed when the user turns on the undocking switch 21 in a state where the computer 10 and the docking station 20 are connected, and the power supply of the personal computer 10 is turned on.

When the user presses the undocking switch 21, the EC/KBC IC 170 receives a button signal indicating that the undocking switch 21 is turned on, via the docking interface connector 26.

Upon reception of the button signal, the EC/KBC IC 170 detects that the user has pressed the undocking switch 21. The EC/KBC IC 170 sends an interrupt to the CPU 111 to notify the system BIOS of an event (undocking switch-on event) indicating that the undocking switch 21 has been operated, i.e., that a removing request of the docking station 20 has been issued (block S201).

The system BIOS determines whether the main operating system or the sub operating system is currently booted (block S202).

When the main operating system is currently booted, the system BIOS notifies the currently executed main operating system of the event (undocking switch-on event) indicating that the removing request of the docking station 20 has been issued (block S203).

The main operating system executes the device removing process (safety removing process) for setting the system environment of the computer 10 to a state where the external device (docking station 20) designated by the undocking switch-on event can be removed from the computer main body 11 (block S204).

This safety removing process is a process of stopping a service for accessing the external device (docking station 20) designated by the undocking switch-on event. After this operation, the docking station 20 is removed from the list of hardware resources used by the computer 10. That is, the external device (docking station 20) is operatively separated from the computer 10. As a result, the external device (docking station 20) can be physically and safely removed from the computer 10.

Upon completion of the device removing process, the main operating system displays, on the LCD 17, a message indicating that the external device (docking station 20) can be safely removed (block S205). In block S205, the operating system notifies the system BIOS that the safety removing process has been performed.

The system BIOS instructs the EC/KBC IC 170 to turn off the power supply of the external device (docking station 20), i.e., to stop power supply to the external device (docking station 20) (block S206).

The EC/KBC IC 170 controls the power supply circuit 180 to stop power supply to the docking station 20. With this operation, the power supply of the external device (docking station 20) is turned off, and the power supply of the LED 22 is turned off.

On the other hand, when the sub operating system is currently booted, the system BIOS notifies the currently executed sub operating system of the event (undocking switch-on event) indicating that the removing request of the docking station 20 has been issued (block S208).

The sub operating system executes the device removing process (safety removing process) for setting the system environment of the computer 10 to a state where the external device (docking station 20) designated by the undocking switch-on event can be removed from the computer main body 11 (block S209).

Upon completion of the device removing process, the sub operating system can display, for example, on the LCD 17, a message indicating that the external device (docking station 20) can be safely removed (block S210). In block S210, the sub operating system notifies the system BIOS that the safety removing process has been performed.

The system BIOS instructs the EC/KBC IC 170 to turn off the power supplies of the personal computer (computer 10) and the external device (docking station 20), i.e., to stop power supply to the personal computer (computer 10) and the external device (docking station 20) (block S211).

The EC/KBC IC 170 controls the power supply circuit 180 to stop power supply to the computer 10 and the docking station 20. With this operation, the power supplies of the personal computer (computer 10) and the external device (docking station 20) are turned off, and the power supply of the LED 22 is turned off.

As described above, when the undocking switch 21 is operated while the sub operating system is booted, in addition to the device removing process, the computer 10 is automatically turned off after the device removing process. This is because the sub operating system is dedicated software for playing back the audio/video data stored in the ODD 24, and is not used after undocking. The user can turn off the power supplies of both the computer 10 and docking station 20, simply by operating the undocking switch 21.

As described above, in this embodiment, the user can easily select the operating system that he or she wants to use, simply by operating the switches of the information processing apparatus and the external device. According to this embodiment, when the sub operating system is executed, the user can also turn off the power supplies of both the computer 10 and the docking station 20 simply by operating the undocking switch 21.

In this embodiment, the above described removing process is executed by operating the undocking switch 21 arranged on the docking station 20. However, for example, the removing process can be executed by operating the DVD/CD start button switch 25A in place of the undocking switch 21. Also, a new input unit can be arranged on the computer main body 11 to request an undocking process.

In this embodiment, a docking station is described as an example of the external device. However, various devices, such as a storage device capable of storing data, which can be connected to the computer 10 via a cable or connector can also be used as the external device.

In the illustrated embodiment, the ODD 24 is connected to the computer 10 using a USB interface. However, various interfaces, such as PCI Express, Serial Advanced Technology Attachment (SATA), Institute of Electrical and Electronics Engineers (IEEE) 1394, capable of hot plug/hot unplug process can also be used between the computer 10 and the external device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of automatically selecting an operating system to be booted up in a computer, the method comprising:
receiving an indication that a switch on a docking station coupled to the computer has been activated, where the docking station has an optical disk drive;
determining an operational state of the computer; and
when the operational state is “off,” booting up a sub operating system for the computer and turning on at least a portion of the computer and the docking station, where the portion includes at least a display unit of the computer and the optical disk drive of the docking station, where the sub operating system has fewer features than a main operating system also present on the computer.

2. The method of claim 1, wherein determining an operational state comprises determining whether the computer is “on” or “off,” where “on” corresponds to an operating state using a main operating system, and where “off” corresponds to a state in which at least one power supply for the computer is deactivated.

3. The method of claim 1, further comprising when the operational state is “on,” launching an application program that uses the main operating system, where the application accesses data from an optical disk loaded in the optical disk drive.

4. The method of claim 1, further comprising setting a system environment to a safe state for removal of the docking station upon receiving an indication that a second switch on the docking station has been activated.

5. The method of claim 4, further comprising deactivating power supplied to both the computer and the docking station at least partially in response to the activation of the second switch when the computer is operating with the sub operating system.

6. The method of claim 4, further comprising deactivating power supplied to the docking station, but not to the computer at least partially in response to the activation of the second switch when the computer is operating with the main operating system.

7. The method of claim 1, wherein the method is embodied in a system basic input output system (BIOS) of the computer.

8. A method of automatically selecting an operating system to be booted up in a computer, the method comprising:
determining whether a first switch on the computer or a second switch on an external device has been activated for activation of the computer;
if the first switch has been activated, powering up the computer and booting up a first operating system; and
if the second switch has been activated, powering up the computer an the external device and booting up a second operating system different from the first operating system.

9. The method of claim 8, wherein the computer comprises a notebook computer and the external device comprises a docking station for the notebook computer, where the docking station has an optical disk drive and the second switch is associated with to activation of the optical disk drive.

10. The method of claim 8, wherein the second operating system has fewer functions than the first operating system, where the second operating is operable to display multimedia data from the external device on the computer.

11. An apparatus comprising:
at least one controllable power supply;
a mass storage device having stored thereon computer executable instructions for a main operating system and a sub operating system, where the sub operating system has fewer features-than the main operating system;
at least one interface connector for communicating with an external device; and
a circuit configured to select the sub operating system from the mass storage device for bootup when a signal is received from the interface connector and the power supply is not enabled.

12. The apparatus of claim 11, wherein the apparatus comprises a notebook computer with a display, wherein the external device with which the interface connector communicates comprises a docking station with an optical disk drive, and wherein the signal received from the interface connector is derived from a switch on the docking station.

13. The apparatus of claim 12, further comprising the docking station.

14. The apparatus of claim 11, further comprising a power switch on the apparatus, wherein the circuit is further configured to select the main operating system from the mass storage device for bootup at least partially in response to activation of the power switch.

15. The apparatus of claim 11, wherein the circuit is further configured to enable launching of an application for viewing a multimedia file when the signal is received from the interface connector and the power supply is enabled.

16. The apparatus of claim 11, further comprising a USB interface circuit for data communication with the external device.

17. The apparatus of claim 11, wherein the circuit is further configured to set a system environment to a safe state for disengagement of the external device from the interface connector at least partially in response to a second signal received from the interface connector.
